(19) United States
(12) Patent Application Publication
(10) Pub. No.: US 2011/0066685 A1
(43) Pub. Date: Mar. 17, 2011

(54) SENDING EMAIL FROM A DOCUMENT STORAGE SERVER OPERATING BY MOBILE DEVICE REMOTE FROM THE DOCUMENT STORAGE SERVER

(76) Inventors: Hiroshi KITADA, Tuckahoe, NY (US); Lana WONG, Randolph, NJ (US)

(21) Appl. No.: 12/558,135

(22) Filed: Sep. 11, 2009

(51) Int. Cl. G06F 15/16

(52) U.S. Cl. 709/206

(57) ABSTRACT

An attachment server including a request reception unit that receives an email and a document request from a mobile terminal, a document obtaining unit that obtains the requested document from a document storage server, an attachment unit that attaches the document obtained by the document obtaining unit to the email received from the mobile terminal and a transferring unit that transfers the email including the attached document, to an email delivery server.

### BACKGROUND OF THE INVENTION

The present invention relates to a system and method of sending email via a document storage server such as DocumentMall™ by a mobile device remote from the Documentmall™ server. Conventionally it has been difficult to access documents stored in document storage system such as DocumentMall™ using a mobile device which includes a limited screen size.

### SUMMARY OF THE INVENTIONS

Accordingly the present inventions provides inter alia a method of sending an email including a document stored in a document storage server using a mobile device remote from the document storage server. The method includes a step of sending an email including a request to attach the document stored in the document storage server, to an attachment server and a step of obtaining, at the attachment server, the requested document from the document storage server. Further the method includes the steps of attaching, at the attachment server, the document obtained by the obtaining to the email received from the mobile device and transferring the email including the attached document, to an email delivery server from the attachment server. Finally, the method includes the steps of sending, using the email delivery server, the email including the attached document, to a recipient identified in the email and receiving a confirmation at the mobile device of the sending of the email from the email delivery server via the attachment server.

Also provided is an email transmission system that includes a mobile terminal, an attachment server, a document storage server and an email delivery server. The mobile terminal includes a processor, a computer readable storage device, and an email sending unit configured to sending an email including a request to attach a document stored in a document storage server, to an attachment server. The attachment server includes a processor, a computer readable storage device, a document obtaining unit configured to obtain the requested document from the document storage server, an attachment unit configured to attach the document obtained by the document obtaining unit to the email received from the mobile terminal and a transferring unit configured to transfer the email including the attached document, to an email delivery server. The document storage server includes a processor, a computer readable storage device, and a document transfer unit configured to transfer the requested document to the attachment server in response to a request from the attachment server. The email delivery server includes a processor, a computer readable storage device, a sending unit configured to send the email including the attached document to a recipient identified in the email, and a configuration unit configured to send a confirmation, via the attachment server, to the mobile terminal indicating the sending of the email from the email delivery server.

Also provided is an attachment server that includes a processor, a computer readable storage device, a request reception unit configured to receive an email and a document request from a mobile terminal, a document obtaining unit configured to obtain the requested document from a document storage server, an attachment unit configured to attach the document obtained by the document obtaining unit to the email received from the mobile terminal and a transferring unit configured to transfer the email including the attached document, to an email delivery server.

### BRIEF DESCRIPTION OF SEVERAL VIEWS OF THE DRAWINGS

Other objects, features and advantages of the present invention will become more apparent from the following detailed description when read in conjunction with the accompanying drawings in which:

FIG. 1 is a block diagram showing an organization of several servers and a mobile device;

FIG. 2 is a flow diagram showing the interaction between a mobile device and an image converting server, a document storage server and a converting tool;

FIG. 3A is a flow diagram showing the method illustrated in FIG. 2;

FIG. 3B continues the flow diagram shown in FIG. 3A;

FIG. 4 shows the mobile device with a selectable icon of the document storage application;

FIG. 5 shows another view of the mobile device displaying a login window of the document storage application;

FIG. 6 shows another view of the mobile device displaying a search window of the Document storage application;

FIG. 7 shows another view of the mobile device search window shown in FIG. 6 in which the search box includes a search term;

FIG. 8 shows another view of the mobile device search window shown in FIG. 6 in which in which results of the search are shown;

FIG. 9 shows the mobile device with a command menu displayed in the document storage application;

FIG. 10 shows the mobile device displaying a window resulting form a selection of document in the document storage application;

FIG. 11 shows the mobile device displaying a menu for selecting a page in the window displayed in FIG. 10;

FIG. 12 shows a flow diagram illustrating the interaction between the mobile device, the image converting server, the document storage server and a SMTP server;

FIG. 13A shows the flow diagram illustrating a process corresponding to the flow diagram shown in FIG. 12;

FIG. 13B continues the flow diagram shown in FIG. 13A;

FIG. 14 shows another view of the mobile device with a command menu displayed in the document storage application;

FIG. 15 shows the mobile device displaying an email address book window of the document storage application;

FIG. 16 shows the mobile device displaying a window showing a response indicating that an email has successfully been sent in the document storage application;

FIG. 17 shows another view of the mobile device with a command menu displayed in the document storage application;

FIG. 18 shows the mobile device displaying a manual email address entry window of the document storage application;

FIG. 19 shows a flow diagram showing the interaction between the mobile device, the document storage server and a printer;

FIG. 20 illustrates a process corresponding to the flow diagram shown in FIG. 19;

FIG. 21 shows another view of the mobile device with a command menu displayed in the document storage application;

FIG. 22 shows a hardware configuration of an apparatus according to an embodiment of the present invention; and

FIG. 23 shows a hardware configuration for a mobile device according to an embodiment of the present invention.

### DETAILED DESCRIPTION OF THE INVENTIONS

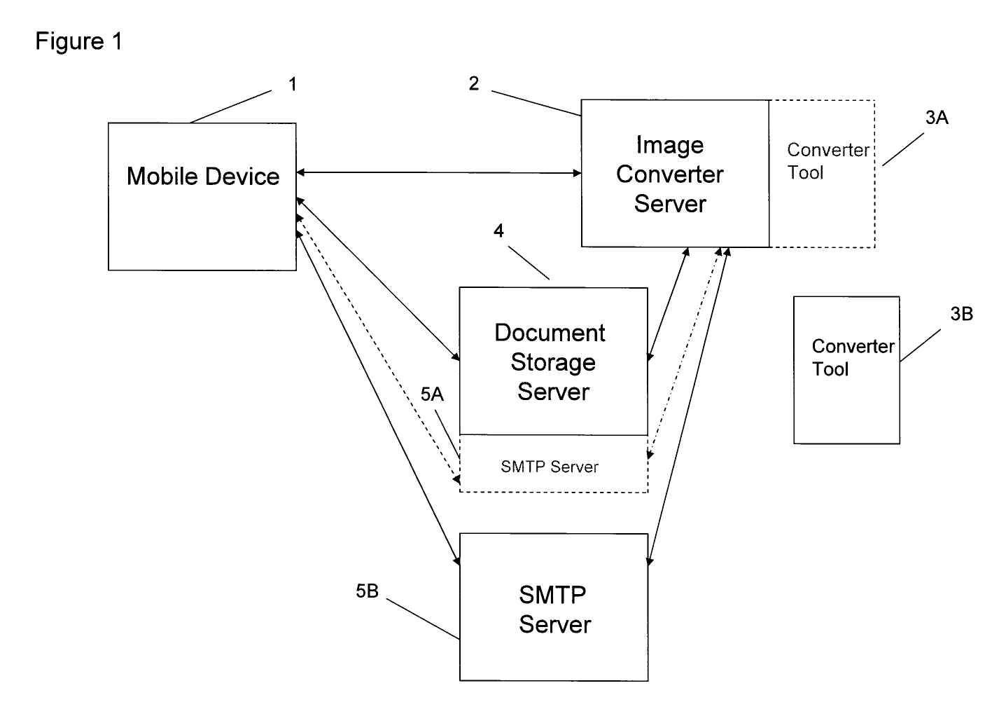

Referring now to the drawings, wherein like reference numbers designate identical or corresponding parts throughout the several views and more particularly to FIG. 1 thereof there is illustrated the structure of the present system for sending email including documents stored on a document storage server 4 using a mobile device 1 remote from the document storage server 4. The document storage server 4 can be, for example, a DocumentMall™ server.

FIG. 1 illustrates the structure of a system which includes a mobile device 1, an image converting server 2 and a document storage server 4.

Also included in the system is a converter tool 3B which is external to the image converting server 2. In an alternative embodiment the converter tool 3A may be incorporated into the image converting server 2. Thus, in one embodiment a converter tool 3A is included in an image converting server 2 and in another embodiment the converter tool 3B is located in a server external to the image converting server 2. As is illustrated in FIG. 1, the mobile device 1 is able to interact with the image converting server 2, the document storage server 4 and the SMTP server 5, directly or indirectly.

In addition to the converter tool 3A/B, the system includes an SMTP server 5 (5A/B) which can be either included in the same server as the document storage server 4 in one embodiment of the SMTP server 5A or be external to the document storage server 4 in another embodiment of the SMTP server 5B.

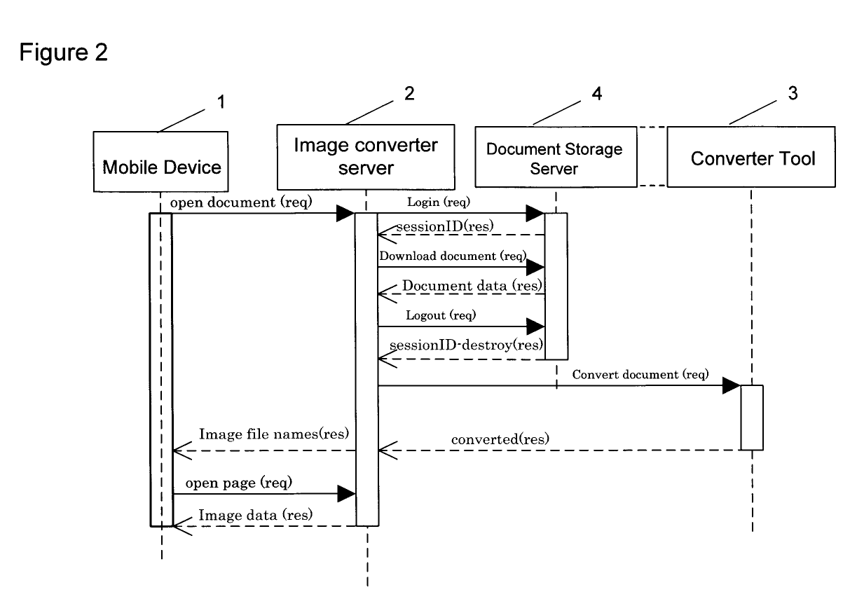

FIG. 2 illustrates the flow diagram showing the interaction between the mobile device 1, the image converting server 2, the document storage server 4 and the converting tool 3 (3A/B). As is illustrated in FIG. 2, when the mobile device 1 sends a document open request to the image converting server (ICS) 2, the image converting server 2 sends a login request to the document storage server 4 using login information received from the mobile device 1.

In response to successful login, the document storage server 4 generates and sends a session ID to the image converting server 2 as a response. The image converting server 2 then sends a download document request to the document storage server 4. The download document request includes the session ID previously received from the document storage server 4. In response, the document storage server 4 sends the requested document data to the image converting server 2. Once the transfer of documents is complete, the image converting server 2 sends a logout request to the document storage server 4. Once the request is received, the document storage server 4 performs a logout operation which invalidates the session ID and sends a response to the image converting server 2 confirming the extinction of the session between the image converting server 2 and the document storage server 4.

The image converting server 2 then uses the converter tool 3 to convert the document downloaded from the document mall server to a form more appropriate for viewing on the mobile device 1.

In one embodiment, the downloaded document sent to the converter tool which converts each page of the downloaded document into PNG files, the PNG files having a pixel size appropriate for display on the mobile device. In one example, the file stored on the document storage server 4 is a PDF document having five pages. After receiving the PDF document from the document storage server 4, the image converting server 2 sends the PDF document to the converter tool 3 which processes the PDF files and produces five PNG files having a pixel size appropriate for the mobile device 1 which requested the document. For example, if the screen size of the mobile device is 320×240, the PNG files can be generated at a pixel size of 320×240. Alternatively, the pixel size of the PNG files could be smaller or larger than the pixel size of the screen of the mobile device. Thus, the converter tool 3 downsizes the pixel size of each page and splits the document having multiple pages into individual page files. In addition, although PNG files are described above, a number of formats such as pdf, tiff, jpg, gif, xml, html etc can be used depending on the display ability of the mobile device.

The image converting server 2, after receiving the converted image files, sends a list of the image file names to the mobile device 1. In response to a user input, the mobile device 1 sends a request for the opening of a particular page to the image converting server 2. The image converting server 2 then processes the request and sends the respective image data to the mobile device 1.

In an alternate embodiment, the image file names are sent to the mobile device 1 before the pages of the downloaded document are converted into image files. Then, when the mobile device 1 sends a request for a page, the image converting server 2 requests that particular page be converted by the converter tool 3. Once the page is received by the image converter server 2, the image converter server 2 forwards the information of the converted page to the mobile device 1.

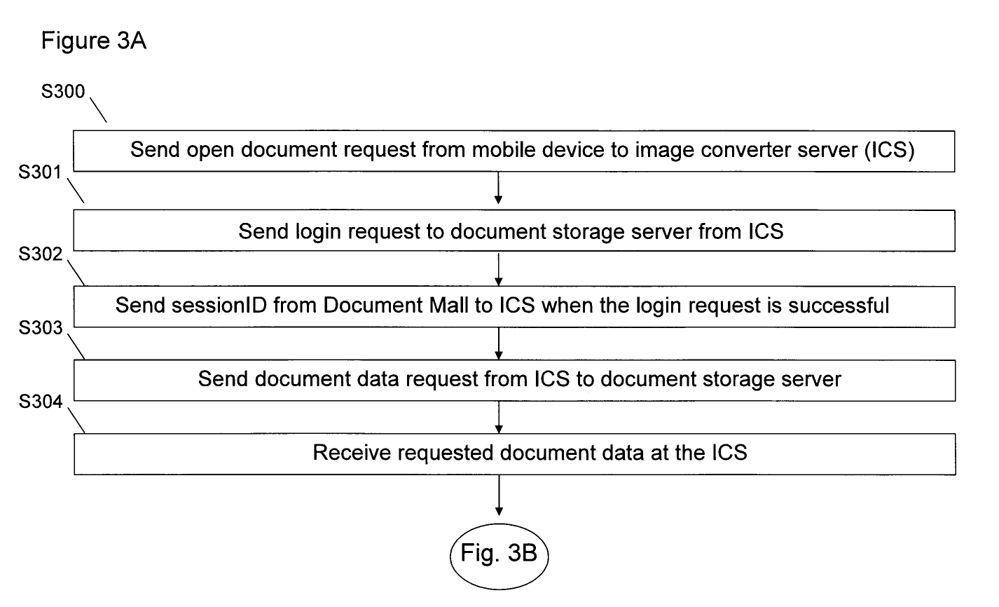

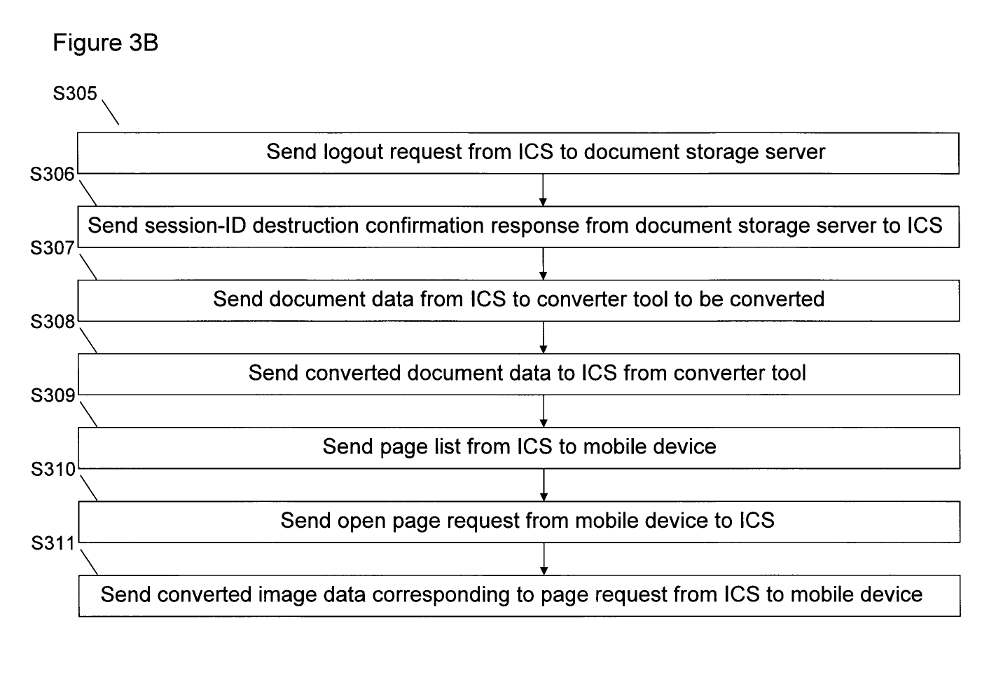

FIG. 3A illustrates a process corresponding to the flow diagram shown in FIG. 2. For example, in step 300, an open document request is sent from the mobile device 1 to the image converting server (ICS) 2. In step 301, a login request is sent to the document storage server 4 from the image converting server 2. In step 302, a session ID is generated and sent from the document storage server 4 to the image converting server 2 in response to a successful login request. In step 303, a document data request is sent from the image converting server 2 to the document storage server 4. In step 304, the requested document data is received at the image converting server 2.

FIG. 3B continues the process shown in FIG. 3A. In step 305, a login request is sent from the image converting server 2 to the document storage server 4. In step 306, a session ID destruction confirmation response is sent from the document storage server 4 to the image converting server 2. In step 307, document data is sent from the image converting server 2 to the converter tool 3 to be converted.

In step 308, the converted document data is sent to the image converter server 2 from the converter tool 3. In step 309, a page listing is sent from the image converter tool 2 to the mobile device 1. In step 310, an open page request is sent from the mobile device 1 to the image converting server 2. Finally, in step 311, the converted image data corresponding to the page request is sent from the image converting server 2 to the mobile device 1.

The process shown in FIGS. 2, 3A and 3B can be executed using at least one server apparatus having a processor and a computer readable storage device. Specifically, this process is tied to the at least one server apparatus which is a particular machine configured to perform this process.

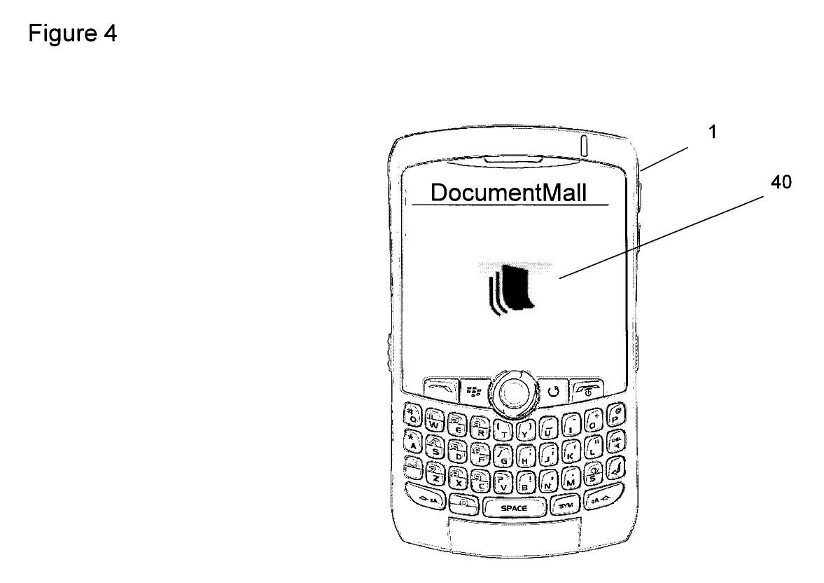

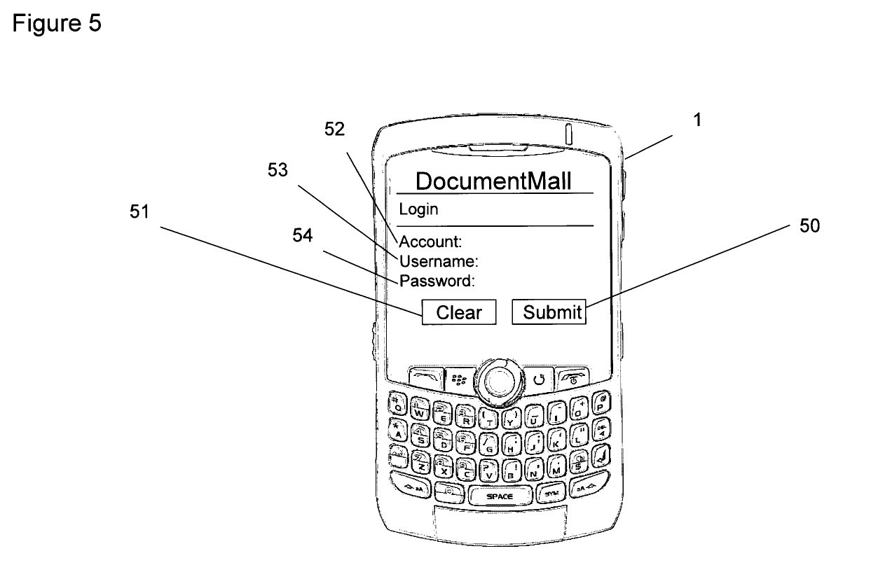

FIGS. 4-11 illustrate the interface of the document storage application, such as DocumentMall™, operating on the mobile device 1. As shown in FIG. 4 the document storage application is executed by selecting the icon 40. In response to selecting the icon 40, the login page shown at FIG. 5 is displayed.

The login page includes an input for a document storage server account name 52, an input for a document storage server user name 53 and an input for a corresponding password 54. In addition, “clear” button 51 and “submit” button 50 are displayed. The clear button clears the entries made in the account name input 52, user name input 53, and password input 54 spaces and the submit button executes the login procedure.

Once the user has logged onto the document storage server, the search window is displayed. It should be noted that in order to log onto the document storage server, the authentication information (account name, user name and password) must be confirmed by the document storage server 4. Once the authentication information is entered the authentication information is transmitted directly from the mobile device 1 to the document storage server 4 where the authentication information is confirmed or denied by the server. Alternatively, the authentication request is transmitted via the image converter server 2 to the document storage server 4.

In one embodiment of the window shown in FIG. 5 once the user has entered the account and user name information the user need not re-enter this information unless the user wants to change this information.

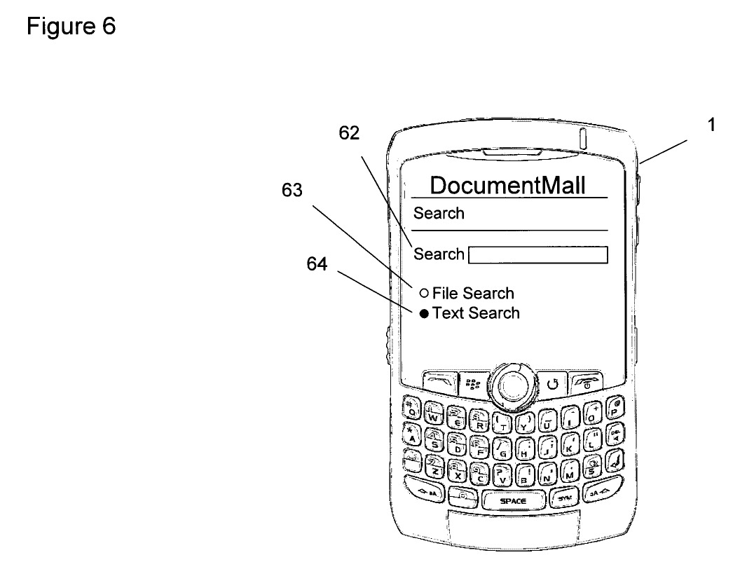

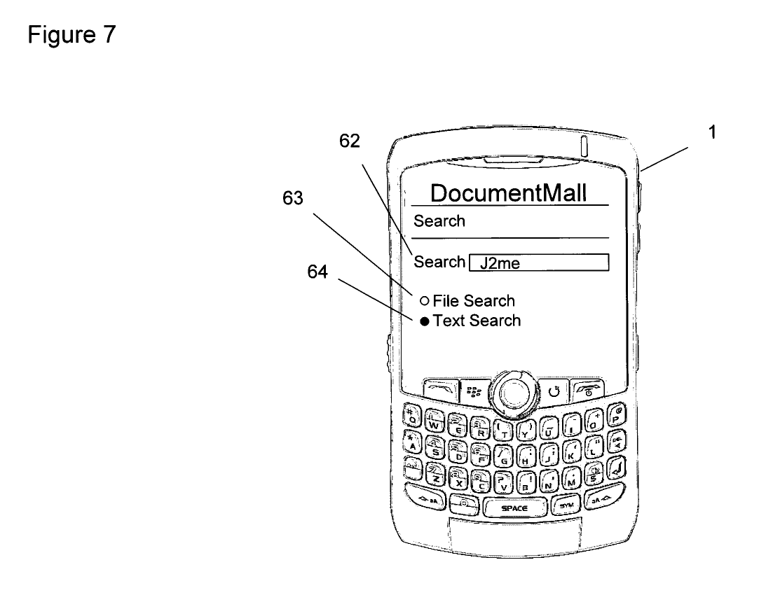

In FIG. 6, the search window includes a search box 62 and toggle buttons 63 and 64 which allow the user to toggle between file search 63 and text search 64. As is shown in FIG. 6, the user is able to search for files and folders by selecting the file search option 63. In addition, the user can search for text in files by selecting the text search option 64. For instance, if the user enters the text J2me as illustrated in FIG. 7, the mobile device sends the request to the document storage server 4 which includes the search term as well as any authentication information which authenticates the request from the mobile device 1. For instance, the authentication information could be the login information provided in FIG. 5 or alternatively, the authentication information could be a session ID provided to the mobile device 1 as a result of the login process illustrated in FIG. 5.

Once the search term is received and the request is authenticated, the document storage server 4 executes a search of a document storage database storing the document and particularly the folders which correspond to the Account associated with the username of the user utilizing the mobile device. The search identifies either documents having the text J2me included or documents or folders with the name J2me. If the user would have selected the file search tab 63, only documents or folders with the name J2me or including the term J2me would have been identified.

Once the results are obtained these results are transmitted to the mobile device 1 from the document storage server 4. Alternatively, the results can be transmitted via the image converter server 2.

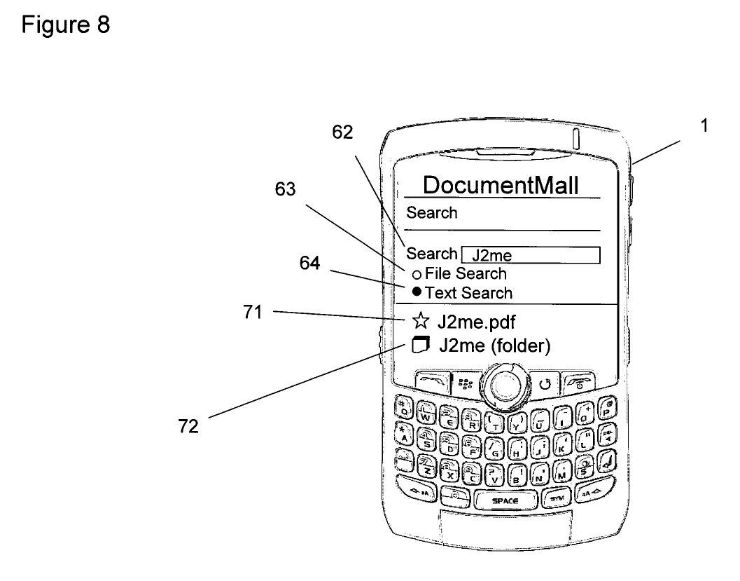

As shown in FIG. 8, once the user has executed the search for the subject matter in search box 62 and the results are received from the document storage server, the results are displayed below the search box. Alternatively, the search results could be displayed on another part of the screen depending on the screen configuration of the mobile device 1.

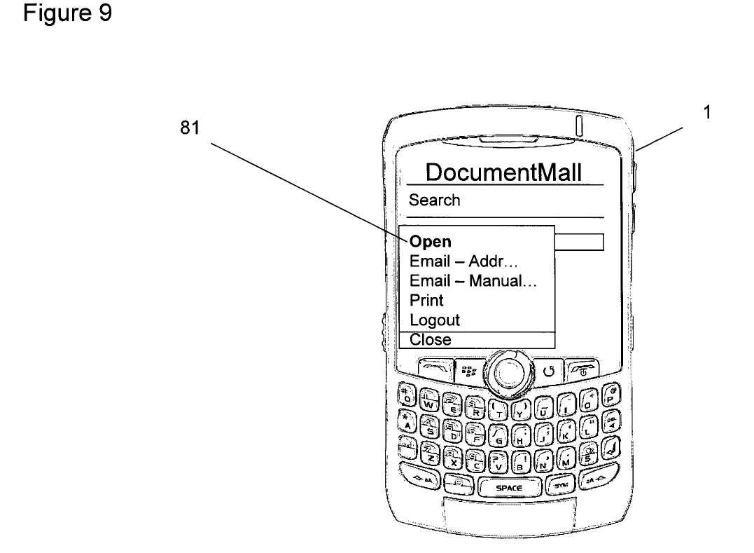

As shown in FIG. 8, the received results are displayed in a list. For example, in FIG. 8, the J2me.pdf 71 file is displayed along with the J2me folder 72. If the user wishes to open either the file J2me.pdf 71 or the folder J2me 72 the user can highlight either of these elements and use the menu 81 shown in FIG. 9 to open the document or folder. Alternatively, if the mobile device 1 includes a touch screen the user can simply select the file name by touching the file name. This open document request corresponds to step 300 shown in FIG. 3A.

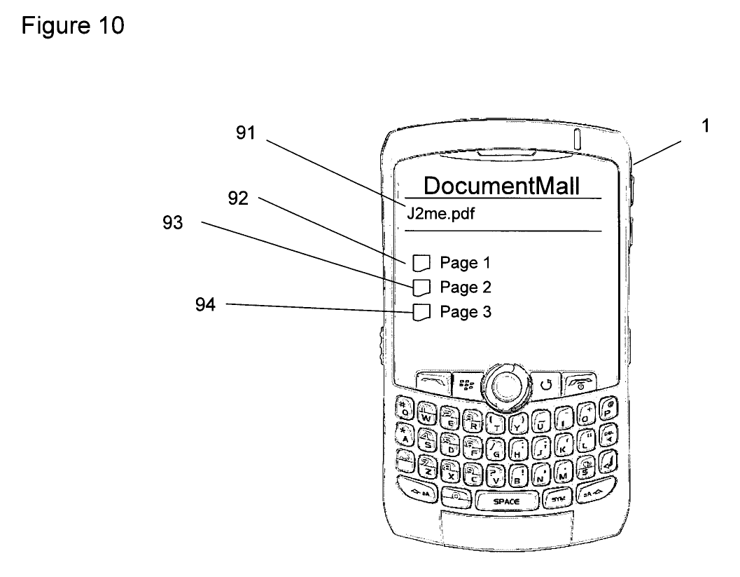

In response to the open document request, a list of pages of the document is received at the mobile device 1. As shown in FIG. 10 the selected document name 91 is displayed a list of the available pages of the document 92, 93 and 94. The receipt of the page list corresponds to step 309 shown in FIG. 3B.

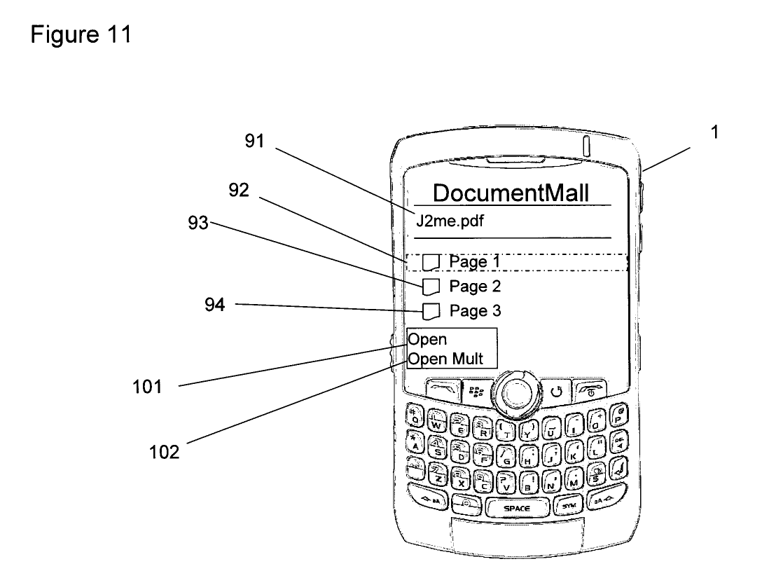

As shown in FIG. 11 if the user wishes to view a particular page, user highlights a page 92, clicks open on the menu 101 or alternatively if the user was to open multiple pages the user can click the open multiple 102, which allows the user to select a page range to open. These commands correspond to steps 310 and 311 shown in FIG. 3B. As is noted above, if the mobile device includes a touch screen these functions may be selectable differently.

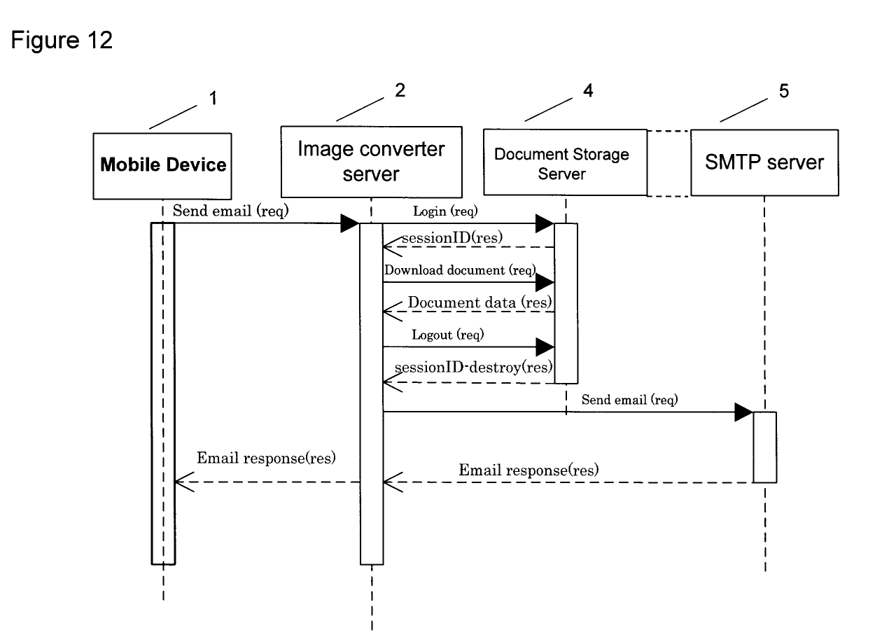

FIG. 12 illustrates the flow in the interaction between the mobile device 1, the image converting server 2, the document storage server 4 and the SMTP server 5. Specifically, FIG. 12 illustrates the process of sending an email which includes document stored in the document mall server 4.

As is shown in FIG. 12, when the mobile device sends an email including a request to include the document stored in the document storage server 4, the image converting server 2 sends a login request to the document mall server using authentication information received from the mobile device 1.

The authentication information is included in the request and enables the image converter server 2 to access the documents stored in the document storage server 4.

When the login information results in a successful login, the session ID is sent from the document storage server 4 to the image converting server 2. The image converting server 2 then sends a document download request which includes the session ID received from the document storage server 4, to the document storage server 4 thus requesting the document which was requested by the mobile device 1.

The document storage server 4 then sends the requested document data to the image converting server 2. The image converting server 2 then requests a logout from the document mall server 4. The document mall server 4 then invalidates the session ID and sends a session ID destroy response confirming the invalidation of the session ID to the image converting server 2.

The image converting server 2 then attaches the downloaded document to the email which is forwarded onto the SMTP server 5. The SMTP server 5 then sends a response to the image converting server 2 indicating that the email was successfully sent. The image converting server 2 forwards this message to the mobile device 1 confirming to the mobile device 1 that the email was successfully sent.

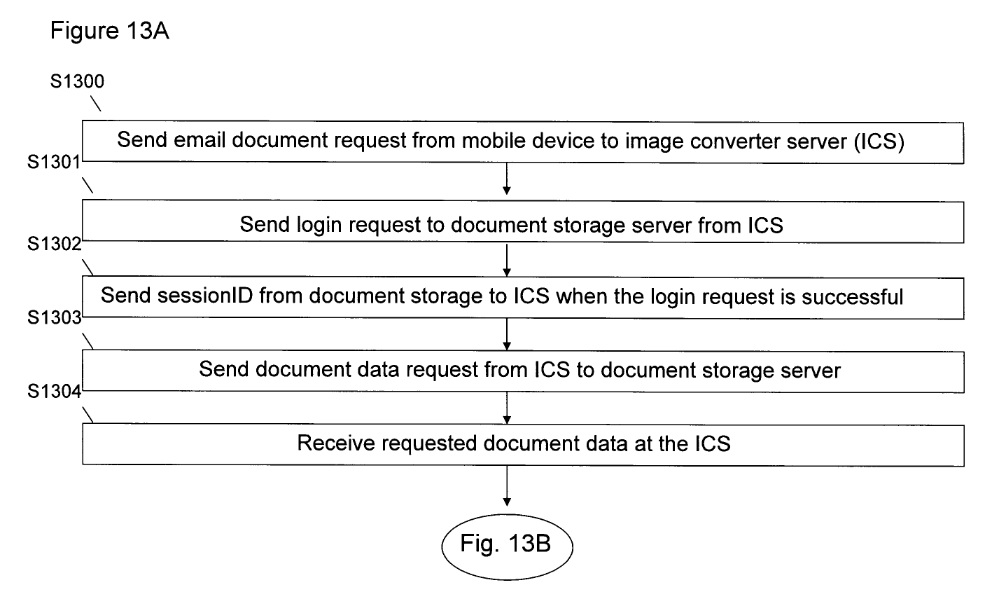

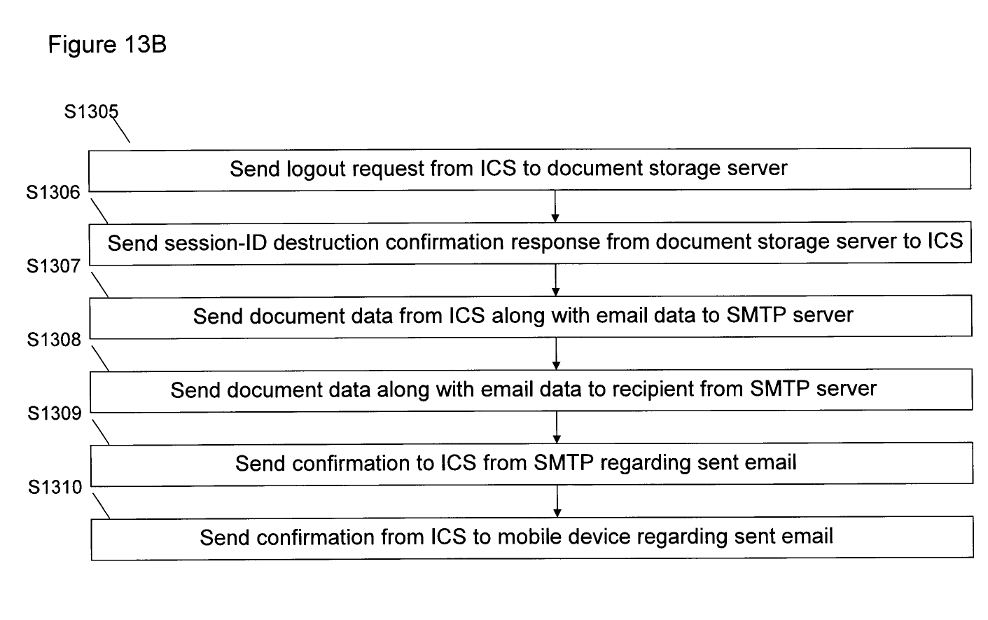

FIGS. 13A and 13B illustrate the process shown in FIG. 12. For example, in step 1300, an email document request is sent from the mobile device 1 to the image converting server (ICS) 2. In step 1301, a login request is sent to the document mall server 4 from the image converting server 2. In step 1302, a session ID is sent from the document storage server 4 to the image converting server 2 when the login request is successful. In Step 1303, a document data request is sent from the image converting server 2 to the document storage server 4. In Step 1304, the requested document data transmitted from the document storage server 4 is received at the image converting server 2.

FIG. 13B continues the process shown in FIG. 13A. In step 1305, a logout request is sent from the image converting server 2 to the document storage server 4. In step 1306, a session ID destruction confirmation response is sent from the document storage server 4 to the image converting server 2. In step 1307, the document data is attached to the email and sent from the image converting server 2 to the SMTP server 5. In step 1308, the document data attached to the email is sent to the recipient from the SMTP server 5.

In step 1309, a confirmation is sent from the SMTP server 5 to the image converting server 2 which confirms the successful sending of the email. In step 1310 the confirmation is forwarded from the image converting server 2 to the mobile device 1 confirming that the email has been sent.

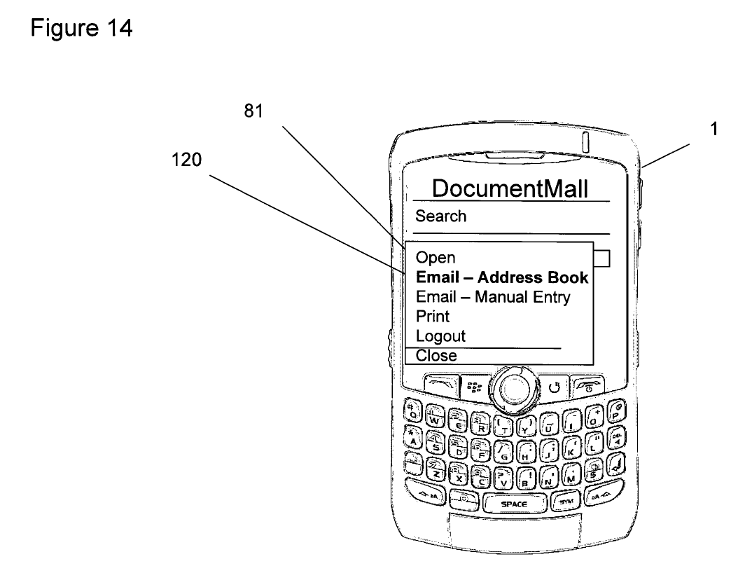

FIGS. 14-18 illustrate the interface on the mobile device 1 which allows a user to email a document that is stored in the document storage server 4. When the user searches for a document and receives the results of the document search as shown in FIG. 8 (results 71 and 72) the user is able to email one of these documents without the need to download the document to the mobile device 1 by selecting the email address book or email manual entry command on the menu 81 illustrated in FIG. 9.

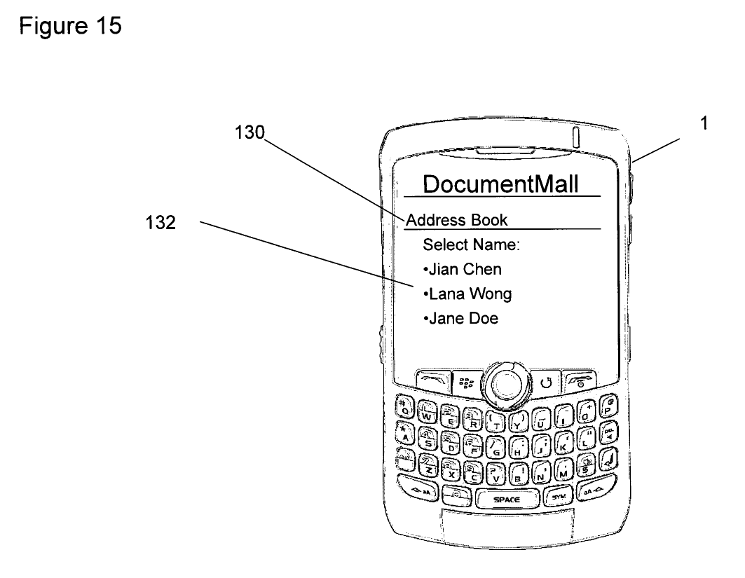

The menu 81 is also illustrated in FIG. 14. In FIG. 14 the email address book option 120 is highlighted. If the user selects this option, the address book selection page is displayed as shown in FIG. 15. In FIG. 15 the address book title 130 is displayed along with the user's address book 132. Once the user has selected one or more names from the address book, the request is sent from the mobile device 1 to the image converting server 2. This step corresponds to step 1300 shown in FIG. 13A.

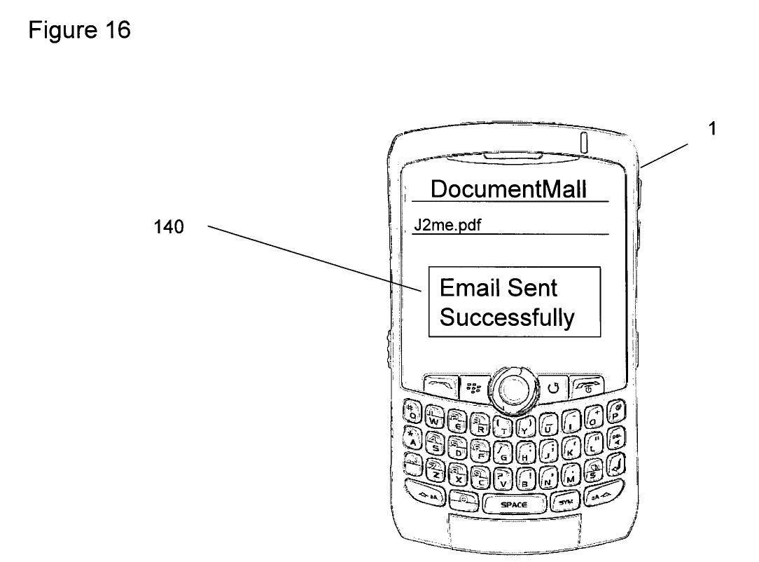

Once the email is sent by the SMTP server 5, a response is received at the mobile device 1. This response 140 which is displayed as shown in FIG. 16 alerts the user to the fact that the response email has been sent successfully. This step corresponds to step 1310 shown in FIG. 13B.

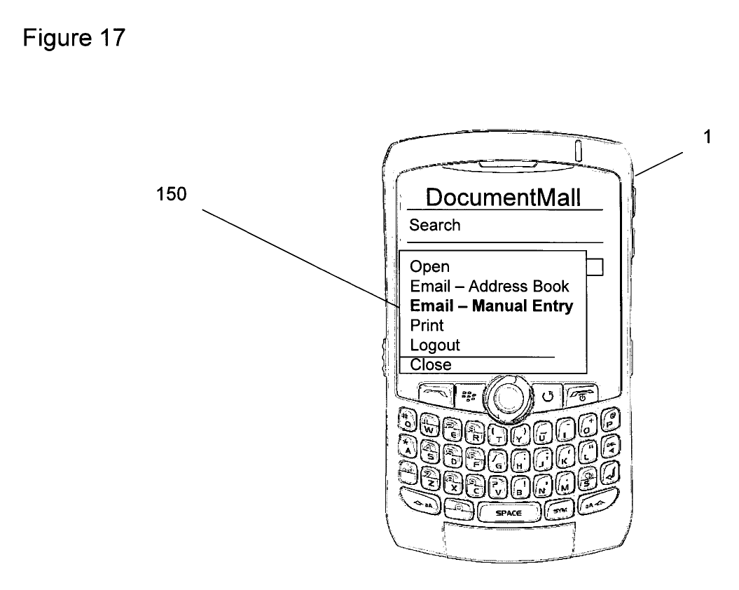

In addition, in the menu 81 shown in FIG. 9 is also illustrated in FIG. 17. In FIG. 17, the Email—manual entry option is highlighted. When the user selects a document, the menu 81 is displayed. Using this menu, the user is able to email the document with the manual address entry 150.

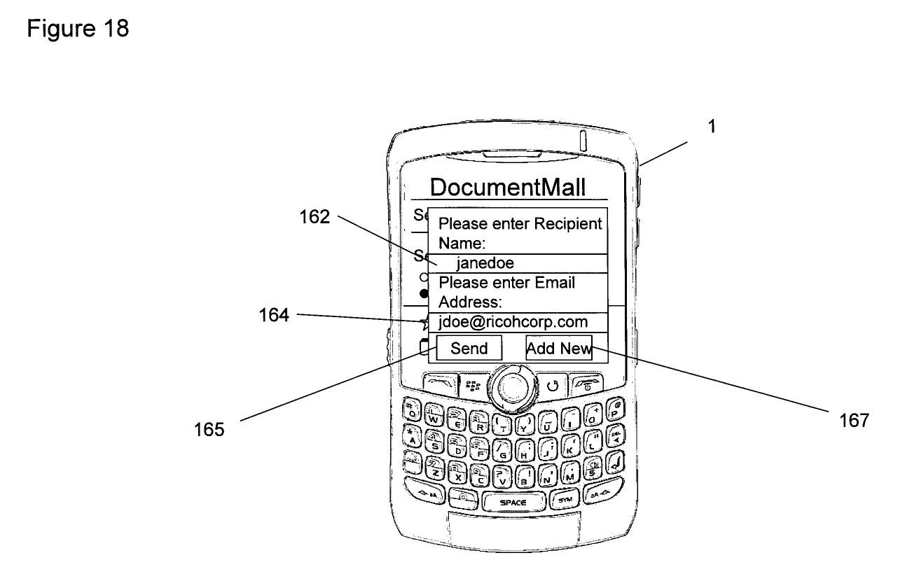

In response to selecting the email manual entry option 150 the window shown in FIG. 18 is displayed. This window allows the user to enter a recipient name 162 and an email address 164. Please note that a user can enter more than one recipient name and email address by selects the “add new” button 167. When the user selects this button, the currently entered recipient name and address are saved and the user has the option to add an additional recipient name and email address. As with the previous embodiment, once the user selects the send button 165 the email request is sent. This command corresponds to step 1300 shown in FIG. 13A. Similar to the other example described above, the user will receive a response 140 from the image converting server 2 letting the user know if the email was sent successfully as is illustrated in FIG. 16.

In an alternative embodiment, once the user selects the send button 165, the user is given the opportunity to enter text which will form the body of the email message. Alternatively, the text which will form the body of the email message can be predetermined.

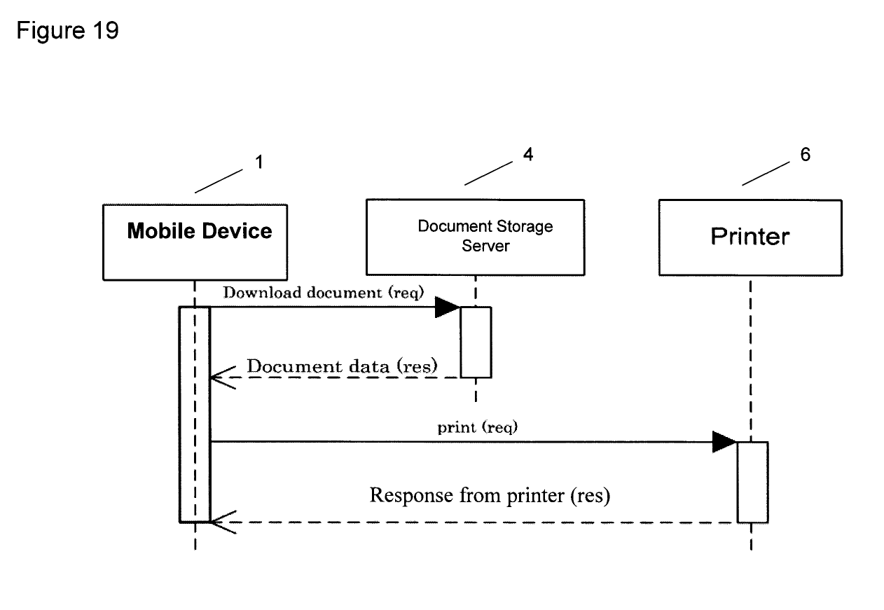

FIG. 19 illustrates the interaction between the mobile device 1, the document storage server 4 and a printer 6 in a system for printing a document stored on the document storage server 4 using mobile device 1.

As is shown in FIG. 19, when the user of the mobile device 1 executes a print request, a download document request is sent to the document storage server 4. After processing the request, the document storage server 4 sends the document data to the mobile device 1 which sends the received document data to the printer 6. The printer 6 is then able to send a response back to the mobile device 1 letting the mobile device know that the data has been successfully received.

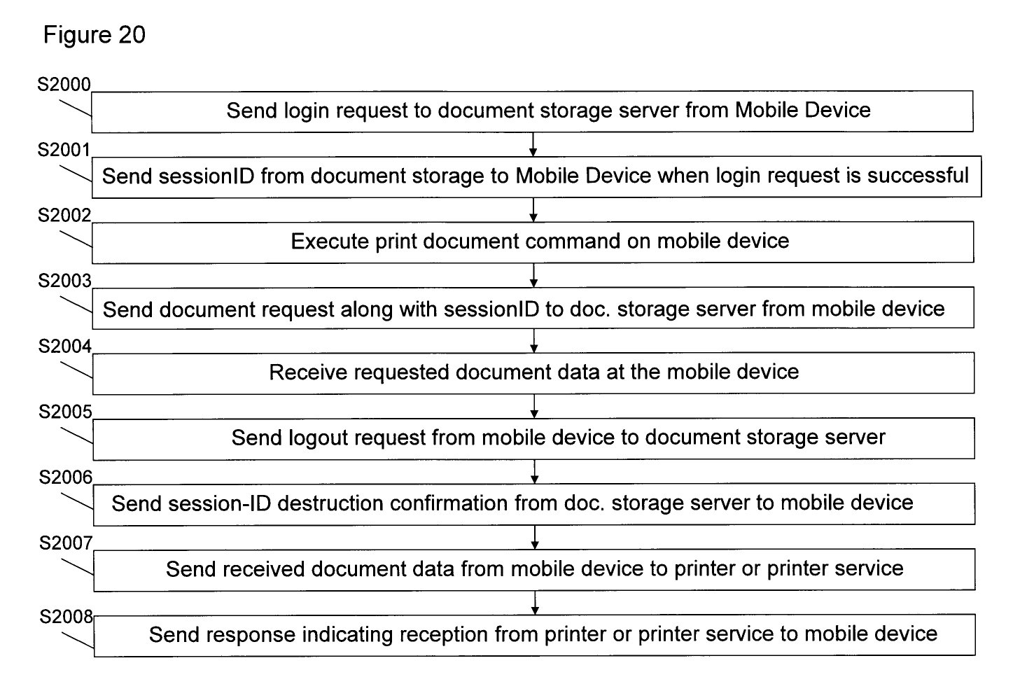

FIG. 20 illustrates a flowchart showing the method corresponding to the flow diagram shown in FIG. 19. In step 2000, a login request is sent to the document storage server 4 from the mobile device 1. In response, if the login request is successful, the document storage server 4 sends a session ID to the mobile device in step 2001. In step 2002, a print document command is executed on the mobile device 1. In step 2003, a document request is sent to the document storage server 4 from the mobile device 1, the document request including a session ID. This session ID was received from the document mall server in step 2001.

In step 2004, the mobile device 1 receives the requested document sent from the document storage server 4. In step 2005, a logout request is sent from the mobile device 1 to the document storage server 4. Alternatively, the mobile device can refrain from sending a login/logout request depending on whether the user remains logged into the document storage server 4. In step 2006, a session ID destruction confirmation is sent from the document storage server 4 to the mobile device 1 confirming to the mobile device 1 that the user has been logged out. Once the mobile device has received the document data in step 2007, the document data is sent from the mobile device 1 to a printer 6 or a printer service. In step 2008 a response is sent from the printer 6 or printer service indicating to the mobile device 1 that the document data has been received.

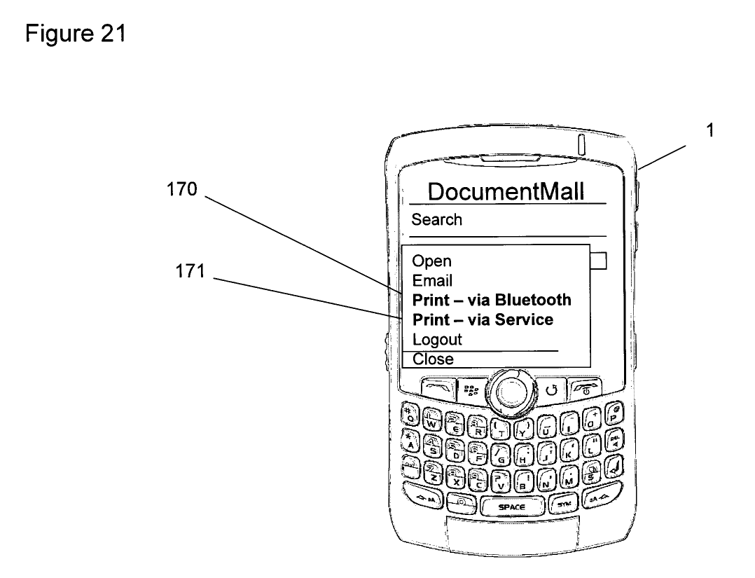

FIG. 21 illustrates the display on the mobile device in which the print via Bluetooth 170 and print via server 171 options are displayed in the command window 81. When either of these commands is executed the process corresponds to step 2000 shown in FIG. 20.

After the user has received the downloaded document data from the document storage server 4, which is sent in response to selecting the print via Bluetooth command in menu 81, the document is sent via Bluetooth, or alternatively via some other wireless connection such as WIFI, to a printer 6 which is previously paired with the mobile device 1. Alternatively, if the user selects the print via service option, the user can print the received document using an external printing service such as Printeron™. When using such a service the user will have to enter a security code before the document is able to be printed using such a service.

Further, when the user clicks the logout button, such a command will remove the session between the mobile device 1 and the document storage server 4 such that when the user wishes to utilize the document mall application the user will have to re-enter his authentication information.

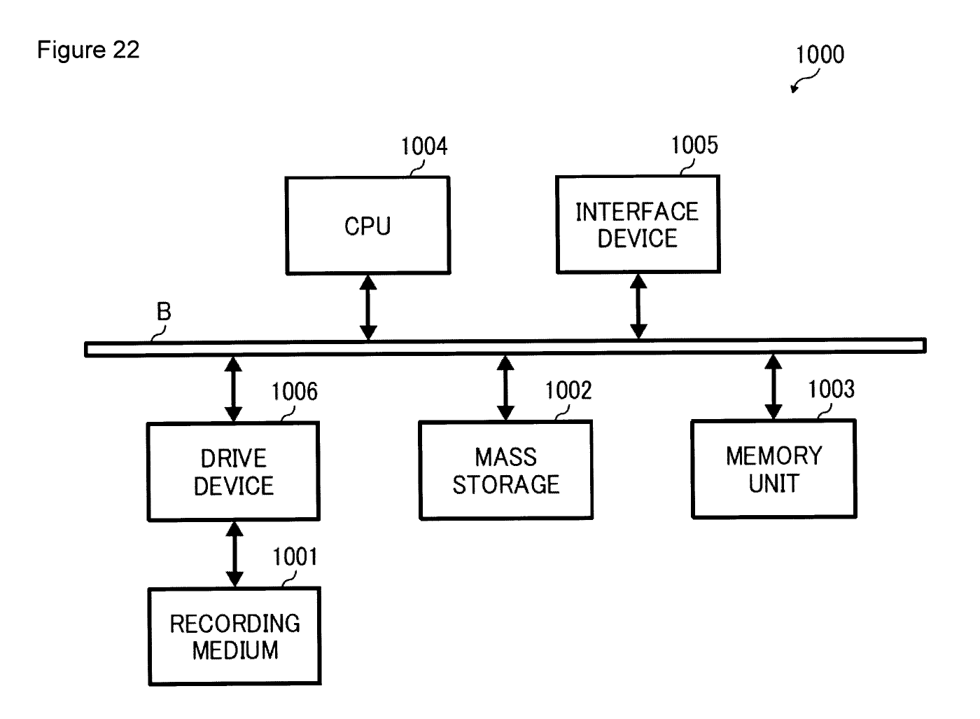

FIG. 22 illustrates a computer system 1000 upon which an embodiment of the present invention may be implemented. The computer system 1000 includes a bus B or other communication mechanism for communicating information, and a processor/CPU 1004 coupled with the bus B for processing the information. The computer system 1000 also includes a main memory/memory unit 1003, such as a random access memory (RAM) or other dynamic storage device (e.g., dynamic RAM (DRAM), static RAM (SRAM), and synchronous DRAM (SDRAM)), coupled to the bus B for storing information and instructions to be executed by processor/CPU 1004. In addition, the memory unit 1003 may be used for storing temporary variables or other intermediate information during the execution of instructions by the CPU 1004. The computer system 1000 may also further include a read only memory (ROM) or other static storage device (e.g., programmable ROM (PROM), erasable PROM (EPROM), and electrically erasable PROM (EEPROM)) coupled to the bus B for storing static information and instructions for the CPU 1004.

The computer system 1000 may also include a disk controller coupled to the bus B to control one or more storage devices for storing information and instructions, such as mass storage 1002, and drive device 1006 (e.g., floppy disk drive, read-only compact disc drive, read/write compact disc drive, compact disc jukebox, tape drive, and removable magneto-optical drive). The storage devices may be added to the computer system 1000 using an appropriate device interface (e.g., small computer system interface (SCSI), integrated device electronics (IDE), enhanced-IDE (E-IDE), direct memory access (DMA), or ultra-DMA).

The computer system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1000 may also include a display controller coupled to the bus B to control a display, such as a cathode ray tube (CRT), for displaying information to a computer user. The computer system includes input devices, such as a keyboard and a pointing device, for interacting with a computer user and providing information to the processor. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system 1000 performs a portion or all of the processing steps of the invention in response to the CPU 1004 executing one or more sequences of one or more instructions contained in a memory, such as the memory unit 1003. Such instructions may be read into the memory unit from another computer readable medium, such as the mass storage 1002 or a removable media 1001. One or more processors in a multi-processing arrangement may also be employed to execute the sequences of instructions contained in memory unit 1003. In alternative embodiments, hard-wired circuitry may be used in place of or in combination with software instructions. Thus, embodiments are not limited to any specific combination of hardware circuitry and software.

As stated above, the computer system 1000 includes at least one computer readable medium 1001 or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other medium from which a computer can read.

Stored on any one or on a combination of computer readable media, the present invention includes software for controlling the computer system 1000, for driving a device or devices for implementing the invention, and for enabling the computer system 1000 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the CPU 1004 for execution. A computer readable medium may take many forms, including but not limited to, non-volatile media, and volatile media. Non-volatile media includes, for example, optical, magnetic disks, and magneto-optical disks, such as the mass storage 1002 or the removable media 1001. Volatile media includes dynamic memory, such as the memory unit 1003.

Various forms of computer readable media may be involved in carrying out one or more sequences of one or more instructions to the CPU 1004 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1000 may receive the data on the telephone line and use an infrared transmitter to convert the data to an infrared signal. An infrared detector coupled to the bus B can receive the data carried in the infrared signal and place the data on the bus B. The bus B carries the data to the memory unit 1003, from which the CPU 1004 retrieves and executes the instructions. The instructions received by the memory unit 1003 may optionally be stored on mass storage 1002 either before or after execution by the CPU 1004.

The computer system 1000 also includes a communication interface 1005 coupled to the bus B. The communication interface 1004 provides a two-way data communication coupling to a network that is connected to, for example, a local area network (LAN), or to another communications network such as the Internet. For example, the communication interface 1005 may be a network interface card to attach to any packet switched LAN. As another example, the communication interface 1005 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1005 sends and receives electrical, electromagnetic or optical signals that carry digital data streams representing various types of information.

The network typically provides data communication through one or more networks to other data devices. For example, the network may provide a connection to another computer through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, coaxial cable, optical fiber, etc). The signals through the various networks and the signals on the network and through the communication interface 1005, which carry the digital data to and from the computer system 1000 maybe implemented in baseband signals, or carrier wave based signals. The baseband signals convey the digital data as un-modulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as un-modulated baseband data through a “wired” communication channel and/or sent within a predetermined frequency band, different than baseband, by modulating a carrier wave. The computer system 1000 can transmit and receive data, including program code, through the network and the communication interface 1005. Moreover, the network may provide a connection to a mobile device such as a personal digital assistant (PDA) laptop computer, or cellular telephone.

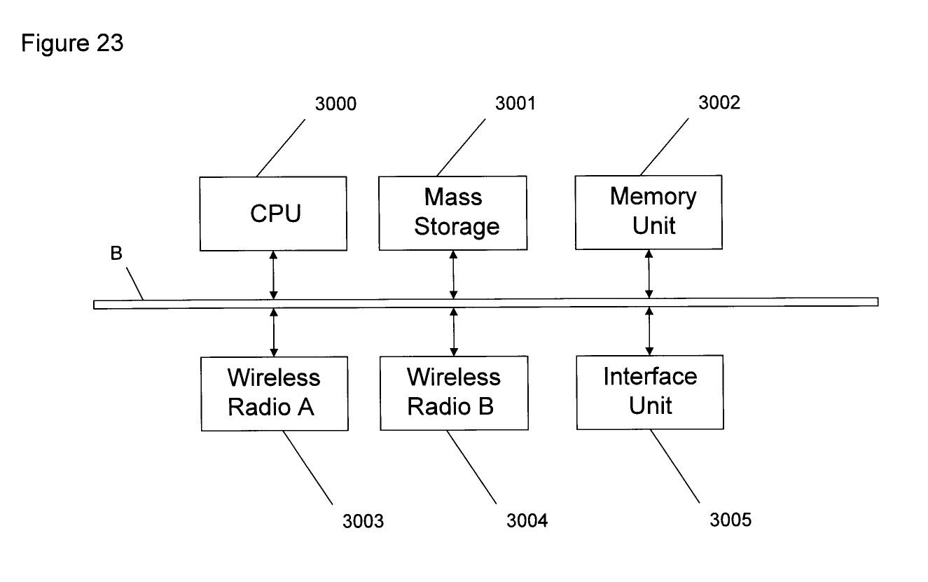

FIG. 23 illustrates a mobile device 1 upon which an embodiment of the present invention may be implemented. The mobile device 1 includes a bus B or other communication mechanism for communicating information, and a processor/CPU 3000 coupled with the bus B for processing the information. The mobile device 1 also includes a mass storage device 3001 in which information can be stored. Further, the mobile device 1 includes a memory unit 3002 and a user interface unit 3005 by which the user can interact with the mobile device 1. Examples of elements included in the interface unit 3005 are keyboards, trackballs, touch screens, LCD displays, plasma displays, external visual displays, holographic displays, biometric input, auditory input, temperature differential input, etc. Also included in the mobile device 1 are a wireless radio A 3003 and a wireless radio B, in addition, a further wireless radio C . . . N can be included in the mobile device 1. The wireless radio A 3003 and wireless radio B can be a WIFI radio, a mobile radio, a Bluetooth radio, or any other suitable wireless radio device.

The present invention is not limited to the specifically disclosed embodiments, and variations and modifications may be made without departing from the scope of the present invention.

1. A method of sending an email including a document stored in a document storage server using a mobile device remote from the document storage server, the method comprising:
sending an email including a request to attach the document stored in the document storage server, to an attachment server;
obtaining, at the attachment server, the requested document from the document storage server;
attaching, at the attachment server, the document obtained by the obtaining to the email received from the mobile device;
transferring the email including the attached document, to an email delivery server from the attachment server;
sending, using the email delivery server, the email including the attached document, to a recipient identified in the email; and
receiving a confirmation at the mobile device of the sending of the email from the email delivery server via the attachment server.

2. The method of sending an email according to claim 1, further comprising:
obtaining, at the attachment server, the requested document from the document storage server using authentication data received from the mobile device.

3. The method of sending an email according to claim 2, further comprising:
logging out of the document storage server in response to receipt of the requested document from the document storage server.

4. The method of sending an email according to claim 1, wherein the attachment server and the document storage server are distinct servers.

5. The method of sending an email according to claim 1, wherein the document storage server and the email delivery server are distinct servers.

6. The method of sending an email according to claim 1, wherein the document storage server and the email delivery server are housed in a same server.

7. The method of sending an email according to claim 1, further comprising:
displaying a list of documents stored on the document storage server on the mobile device.

8. The method of sending an email according to claim 7, the displaying further comprising:
displaying, on the mobile device, a list of documents stored on the document storage server and accessible by the mobile device.

9. The method of sending an email according to claim 7, further comprising:
selecting, at the mobile device, a document from the displayed list of documents to be attached to the email.

10. An email transmission system comprising:
a mobile terminal including
a processor,
a computer readable storage device, and
an email sending unit configured to sending an email including a request to attach a document stored in a document storage server, to an attachment server;
the attachment server including
a processor,
a computer readable storage device,
a document obtaining unit configured to obtain the requested document from the document storage server,
an attachment unit configured to attach the document obtained by the document obtaining unit to the email received from the mobile terminal, and
a transferring unit configured to transfer the email including the attached document, to an email delivery server;
the document storage server including
a processor,
a computer readable storage device,
a document transfer unit configured to transfer the requested document to the attachment server in response to a request from the attachment server;
the email delivery server including
a processor,
a computer readable storage device,
a sending unit configured to send the email including the attached document to a recipient identified in the email, and
a configuration unit configured to send a confirmation, via the attachment server, to the mobile terminal indicating the sending of the email from the email delivery server.

11. The system according to claim 10, wherein the document storage server further includes an authentication unit configured to require authentication by the attachment server before the requested document is provided from the document storage server, the authentication based on authentication data received at the attachment server from the mobile terminal.

12. The system according to claim 11, wherein the attachment server further includes a logging out unit configured to log out of the document storage server in response to receipt of the requested document from the document storage server.

13. The system according to claim 10, wherein the attachment server and the document storage server are distinct servers.

14. The system according to claim 10, wherein the document storage server and the email delivery server are distinct servers.

15. The system according to claim 10, wherein the document storage server and the email delivery server are housed in a same server.

16. The system according to claim 10, wherein the mobile terminal further includes a display unit configured to display a list of documents stored on the document storage server.

17. The system according to claim 16, wherein the display unit displays a list of documents stored on the document storage server which are accessible by the mobile terminal.

18. The system according to claim 16, wherein the mobile terminal further includes a selecting unit configured to allow selection of a document, from the displayed list of documents, to be attached to the email.

19. A computer readable storage medium having stored thereon a program that when executed performs a method of sending an email including a document stored in a document storage server using a mobile device remote from the document storage server, the method comprising:
sending an email including a request to attach the document stored in the document storage server, to an attachment server;
obtaining, at the attachment server, the requested document from the document storage server;
attaching, at the attachment server, the document obtained by the obtaining to the email received from the mobile device;
transferring the email including the attached document, to an email delivery server from the attachment server;
sending, using the email delivery server, the email including the attached document, to a recipient identified in the email; and
receiving a confirmation at the mobile device of the sending of the email from the email delivery server via the attachment server.

20. An attachment server comprising:
a processor;
a computer readable storage device;
a request reception unit configured to receive an email and a document request from a mobile terminal;
a document obtaining unit configured to obtain the requested document from a document storage server;
an attachment unit configured to attach the document obtained by the document obtaining unit to the email received from the mobile terminal; and
a transferring unit configured to transfer the email including the attached document, to an email delivery server.
